(19) United States
(12) Patent Application Publication
(10) Pub. No.: US 2015/0360349 A1
(43) Pub. Date: Dec. 17, 2015

(54) Bonnet Nut Socket

(71) Applicant: Dustin Popejoy, Fairbury, IL (US)

(72) Inventor: Dustin Popejoy, Fairbury, IL (US)

(21) Appl. No.: 14/691,801

(22) Filed: Apr. 21, 2015

Related U.S. Application Data
(60) Provisional application No. 62/012,491, filed on Jun. 16, 2014.

(51) Int. Cl. B25B 13/06; B25B 13/50

(52) U.S. Cl. CPC B25B 13/065; B25B 13/5091

(57) ABSTRACT

A socket for removing bonnet nuts. The socket includes a body, a first end with a head, a channel disposed longitudinally through the body, and a second end with a pair of aligned apertures. The head comprises a hexagonal shape and an indentation disposed at each of the vertices of the hexagon, thereby allowing the head to engage with bonnet nuts commonly used with various types of diverter valves. The aligned apertures disposed at the second end of the socket allow an elongated object, such as the shaft of a screwdriver, to be inserted therethrough to assist in applying leverage to the removal of the bonnet nut. The present socket allows for the convenient removal of bonnet nuts that are flush or sub-flush with a finished wall.

### CROSS REFERENCE TO RELATED APPLICATION

This application claims the benefit of U.S. Provisional Application No. 62/012,491 filed on Jun. 16, 2014. The above identified patent application is herein incorporated by reference in its entirety to provide continuity of disclosure.

### FIELD OF THE INVENTION

The present invention relates to socket tools. More specifically, the present invention relates to sockets adapted for the removal of nuts utilized in various plumbing applications, such as shower diverter valves.

### BACKGROUND OF THE INVENTION

The bonnet nut of a bathtub and shower diverter valve can be extremely difficult to remove because diverter valves are flush or sub-flush with a surrounding finished wall, which can make them difficult to grip with conventional tools. Furthermore, the threading of the bonnet nut can become locked with the threading of the valve body due to calcium buildup, the nut can be slick and difficult to grip with conventional wrenches, and the valve body must held steady simultaneously as the bonnet nut is turned. Furthermore, if users twist the valve body too much when attempting to remove the bonnet nut, it can potentially result in hundreds of dollars' worth of damage to the plumbing system that must be fixed by a professional.

One technique to remove a bonnet nut from a diverter valve body is by locking the valve body in place with one wrench and then using a second wrench to apply torque to the bonnet nut. However, it can be challenging to simultaneously hold both wrenches, while ensuring that the valve body does not twist too much. If the wrenches slip or the user allows the valve body to twist too much, it can result in substantial damage to the diverter valve. Another technique to remove a bonnet nut is to apply heat, often using a rag laden with hot water, to the bonnet nut in order to loosen it. However, this is unreliable and can be very time consuming. Still yet another technique to remove a bonnet nut is to apply WD-40 or another such penetrating oil to the threading between the valve body and the bonnet nut. However, penetrating oil may not be sufficient to break the nut-body connection if there is a substantial amount of calcium buildup. Therefore, there is a need in the prior art for a device specifically adapted to remove bonnet nuts from bathtub and shower valve bodies, without causing damage to the valves.

### SUMMARY OF THE INVENTION

In view of the foregoing disadvantages inherent in the known types of sockets now present in the prior art, the present invention provides a bonnet nut socket wherein the same can be utilized for providing convenience for the user when removing the bonnet nut from a shower diverter valve. The present socket comprises a body, a first end with a head, a channel disposed longitudinally through the body, and a second end with a pair of aligned apertures. The head comprises a hexagonal shape and an indentation disposed at each of the vertices of the hexagon, thereby allowing the head to engage with bonnet nuts commonly used with various types of diverter valves. The aligned apertures disposed at the second end of the socket allow an elongated object, such as the shaft of a screwdriver, to be inserted therethrough to assist in applying leverage to the removal of the bonnet nut. The present socket allows for the convenient removal of bonnet nuts that are flush or sub-flush with a finished wall.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2 shows an elevation view of the first end of the present invention.

FIG. 3 shows an elevation view of the second end of the present invention.

FIG. 4 shows a cross-sectional view of the present invention along line 4-4.

FIG. 5 shows a perspective view of the present invention aligned with a diverter valve.

FIG. 6 shows a perspective view of the second end of an alternative embodiment of the present invention.

FIG. 7 shows a perspective view of the second end of an alternative embodiment of the present invention.

### DETAILED DESCRIPTION OF THE INVENTION

Reference is made herein to the attached drawings. Like reference numerals are used throughout the drawings to depict like or similar elements of the diverter valve socket. For the purposes of presenting a brief and clear description of the present invention, the preferred embodiment will be discussed as used for removing a bonnet nut from a shower diverter valve. The figures are intended for representative purposes only and should not be considered to be limiting in any respect.

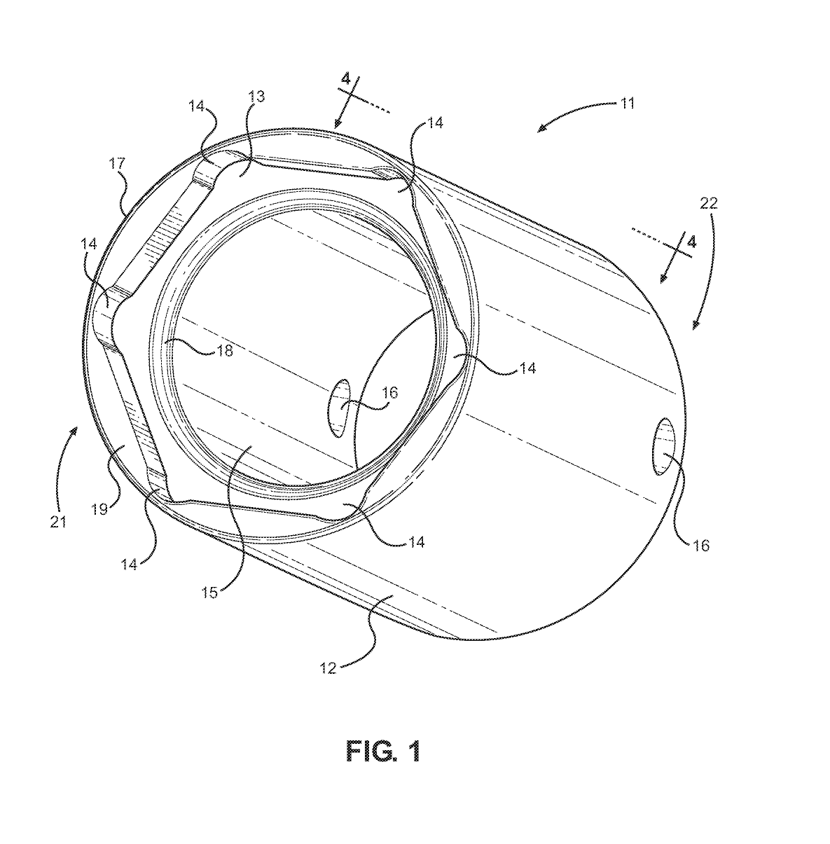

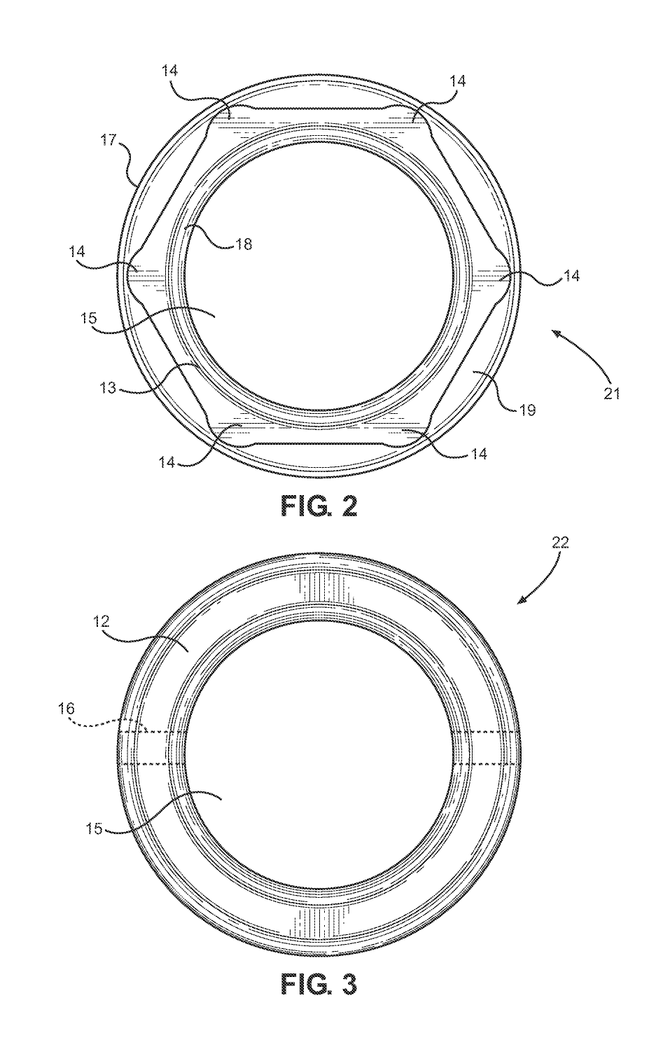

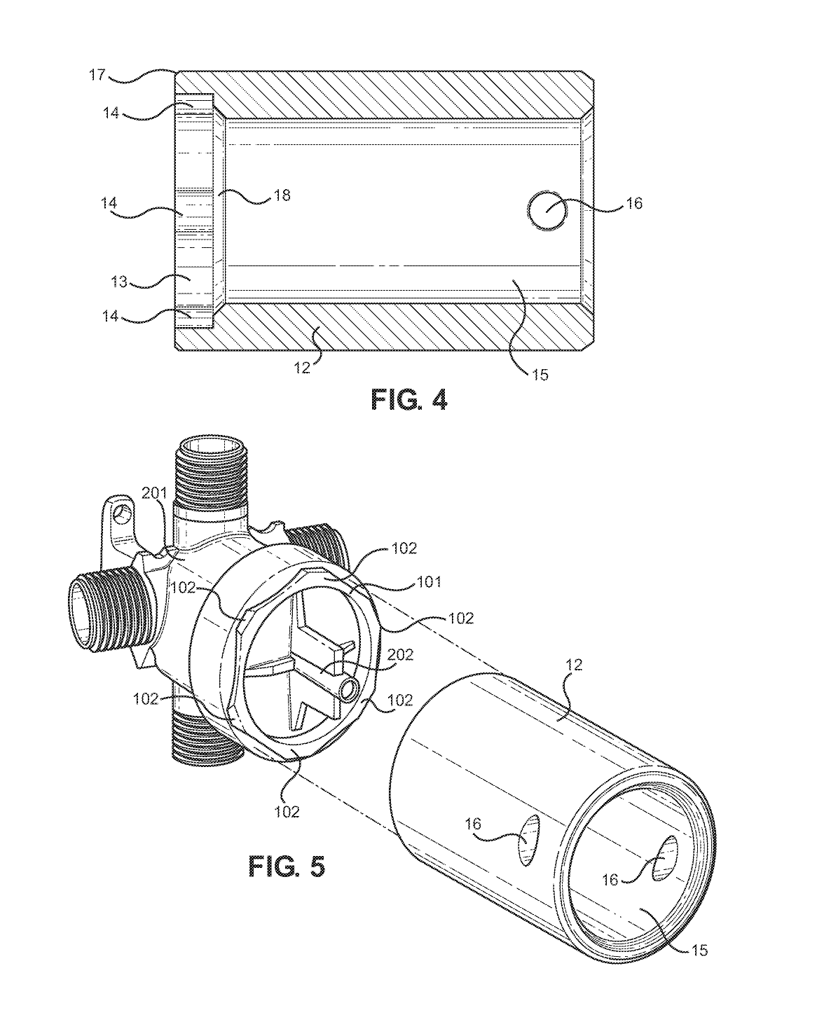

Referring now to FIGS. 1-4, there are shown various views of the present invention. The present invention is a socket 11 adapted for use with bonnet nuts commonly used for shower diverter valves and other such devices. The socket 11 comprises a body 12, a first end 21, and a second end 22. In the depicted embodiment of the present invention, the body 12 comprises a tubular, cylindrical shape; however, no claim is made as to the precise shape of the body 12. The present invention is constructed from a material adapted to resist deformation when the first end 21 is engaged with a nut and torque is applied to the socket 11. In an illustrative embodiment of the present invention, the socket 11 is fabricated from T6 temper 6061 aluminum alloy.

The first end 21 of the socket 11 comprises a head 13 adapted to engage with a complementarily-sized nut. The head 13 comprises a hexagonal shape and a plurality of indentations 14 disposed at each of the vertices of the hexagonal head 13. The head 13 is adapted to engage with nuts that comprise a hexagonal shape and a protrusion disposed at each of the vertices of the hexagonal nut, e.g. bonnet nuts utilized for Delta R10000, Delta R11000, or Brizo 60700 diverter valves. The indentations 14 are sized and shaped to accept the protrusions disposed at the vertices of a hexagonal nut therein and prevent the nut from slipping or otherwise shifting when engaged with the head 13 of the socket 11. In the depicted embodiment of the present invention, the indentations 14 comprise a rounded or hemi-spherical shape. In an illustrative embodiment of the present invention, the indentations 14 comprise an arc length of 0.374 inches and the radius of the arc length segment is equal to 0.31 inches. The head 13 is offset from the face 19 of the first end 21 to a depth slightly larger than the thickness of the nut with which the socket 11 is adapted to engage. This ensures that the entire nut with which the socket 11 is being engaged is fully enclosed by the first end 21 thereof.

The body 12 further comprises a channel 15 extending longitudinally therethrough. The channel 15 allows the socket 11 to be fitted over a bonnet nut disposed on a diverter valve without interference from the stem of the diverter valve, as shown in FIG. 5. In one embodiment of the present invention, the peripheral edge 17 of the first end 21 is chamfered to assist in placing the socket 11 in place onto the diverter valve. In another embodiment of the present invention, the interior edge 18 of the first end is chamfered to assist in placing the channel 15 over the stem of the diverter valve. In these embodiments of the present invention, the peripheral and interior edges 17, 18 can also be filleted, rather than chamfered.

The socket 11 further comprises one or more apertures 16 disposed along a lateral side of the second end 22 for inserting an object therein in order to assist in applying rotational force to the socket 11. In the depicted embodiment of the present invention, the second end 22 of the socket 11 comprises a pair of apertures 16 that are aligned, thereby allowing an elongated, linear object, such as the shaft of a screwdriver, to be inserted therethrough. In the depicted embodiment of the present invention, the apertures 16 are situated 180-degrees apart from each other. When an elongated object is inserted through the apertures 16, the user can actuate the elongated object to turn the socket 11 and thereby apply torque to a nut engaged with the socket 11.

Referring now to FIG. 5, there is shown a perspective view of the present invention aligned with a diverter valve. The body 12 of the socket 11 comprises a rounded shape or otherwise lacks projections therefrom so that it does not have any points that could catch on an adjacent wall when the socket 11 is being used to remove a bonnet nut 102 from a diverter valve 201 that is installed within a wall. In the depicted embodiment of the present invention, the body 12 is cylindrical in shape.

When removing a bonnet nut 101 from a diverter valve 201, the socket 11 is placed onto the bonnet nut 101 such that the indentations of the head align with the projections 102 disposed along the peripheral edge of the substantially hexagonally shaped bonnet nut 101. The diverter valve stem 202 does not interfere with the operation of the socket 11 because it extends into the channel 15 disposed longitudinally through the body 12. Once in place, the socket 11 can then be either turned by hand or actuated via the insertion of an elongated object, such as the shaft of a screwdriver, through the pair of aligned apertures 16 disposed at the second end of the socket 11.

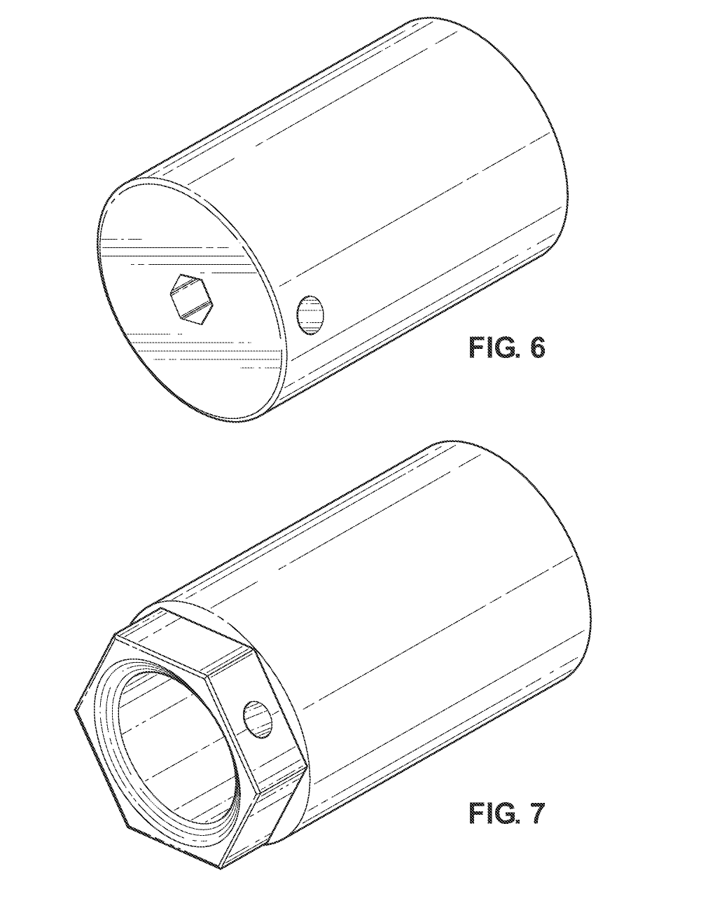

Referring now to FIG. 6, there is shown a perspective view of the second end of an alternative embodiment of the present invention. In this alternative embodiment of the present invention, the second end 22 comprises a recess 31 adapted to receive a complementary drive of a wrench, or another such device. This allows the socket 11 to be placed onto a nut and then tightened or loosened via engagement of a drive with the recess 31. In an illustrative embodiment of the present invention, the recess 31 comprises a hexagonal shape; however, no claim is made as to the precise configuration of the recess 31.

Referring now to FIG. 7, there is shown a perspective view of the second end of an alternative embodiment of the present invention. In this alternative embodiment of the present invention the second end 22 of the socket 11 comprises a hexagonal end 41 adapted to engage with a wrench. This allows the socket 11 to be placed onto a nut and then tightened or loosened via engagement of a wrench with the hexagonal end 41.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A socket, comprising:
a body comprising a channel disposed longitudinally therethrough;
a hexagonal head disposed at a first end of the body, the hexagonal head comprising an indentation disposed at each vertex of the hexagonal head.

2. The socket of claim 1, further comprising:
a first aperture and a second aperture disposed at a lateral side of a second end of the body;
wherein the first aperture and the second aperture are aligned.

3. The socket of claim 2, wherein alignment of the first aperture and the second aperture is adapted to permit an elongated object to be inserted therethrough for applying rotational force to the socket.

4. The socket of claim 1, wherein the body comprises a cylindrical shape.

5. The socket of claim 1, wherein the first end comprises a beveled interior peripheral edge disposed around the channel.

6. The socket of claim 1, wherein the socket is adapted to engage with a bonnet nut of a diverter valve.

7. The socket of claim 1, wherein the socket is fabricated from a material, the material comprising T6 temper 6061 aluminum alloy.

8. The socket of claim 1, wherein the indentations comprise an arcuate shape.

9. The socket of claim 1, wherein the indentations comprise a hemi-circular shape.

10. The socket of claim 1, wherein the head is offset from a face of the first end.

11. The socket of claim 1, wherein the body comprises a rounded shape, free from projections therefrom.

12. The socket of claim 1, further comprising a recess adapted to receive a drive disposed at a second end of the body.

13. The socket of claim 13, wherein the recess comprises a hexagonal shape.

14. The socket of claim 1, further comprising a second end comprising a hexagonal shape.

15. A socket, comprising:
a body comprising a channel disposed longitudinally therethrough;
a hexagonal head disposed at a first end of the body, the hexagonal head comprising an indentation disposed at each vertex of the hexagonal head;
wherein the hexagonal head is recessed from a face of the first end to a depth, the depth adapted to be larger than a thickness of a bonnet nut.
